(19) United States
(12) Patent Application Publication
(10) Pub. No.: US 2011/0186310 A1
(43) Pub. Date: Aug. 4, 2011

(54) SPRAY HEAD

(76) Inventor: Eric Issartel, Vouneuil sur Vienne (FR)

(21) Appl. No.: 13/000,273

(22) PCT Filed: Jun. 19, 2009
(86) PCT No.: PCT/FR2009/051177

§ 371 Date: Feb. 28, 2011

(30) Foreign Application Priority Data
Jun. 20, 2008 (FR) 0854095

(51) Int. Cl. A62C 31/00; A62C 35/00

(52) U.S. Cl. 169/5; 169/37

(57) ABSTRACT

The present invention provides a sprinkler head for mounting on a pipe of a fire protection system, in particular for dispensing an extinguishing agent, the head comprising: a body having a transfer channel passing therethrough; and an endpiece comprising a base having an outlet channel passing therethrough, and a shutter closing said outlet channel, the endpiece in a “closed” position closing the transfer channel and being suitable for disengaging said transfer channel under the effect of an opening force of less than 1500 N.

### TECHNICAL FIELD

The invention relates to a sprinkler head, in particular for dispensing an extinguishing agent for fighting a fire or for preventing a fire, to a fire protection system including such a sprinkler head, to a method of controlling the supply of an extinguishing agent to a pipe including such a sprinkler head, and to a method of opening a set of sprinkler heads in a fire protection system.

### STATE OF THE ART

Conventionally, automatic protection against fire, in particular in premises, warehouses, refineries, or hydrocarbon storage tanks, is provided by so-called “sprinkler” installations. Such installations comprise a network of pipes, generally installed in a ceiling, and having sprinkler heads inserted therein. Sprinkler heads include a heat-sensitive shutter, generally a fuse that is suitable for melting in the event of temperature rising or a bulb that is suitable for bursting in the same situation. In the standby situation, i.e. when no fire is detected, the pipes contain an extinguishing agent under pressure, e.g. water, foam, or a gas, and the shutter of a sprinkler head prevents any extinguishing agent from escaping. In the event of an abnormal increase in temperature, the fuse melts or the bulb bursts, thereby enabling extinguishing agents to be sprayed immediately in the proximity of the heat source. Thus, in the event of a fire, only those sprinkler heads that are close to the heat source open.

Nevertheless, in certain sensitive zones it is desirable, in the event of an abnormal increase in heat being detected at a particular point in the zone that is covered by the pipe network, for the extinguishing agent to be delivered immediately over the entire zone. For this purpose, it is known to install a protection system that comprises both a detection network, referred to as a “pilot” network, that is suitable for detecting a fire at any point within the zone, and a sprinkler network, referred to as a “deluge” network, comprising a set of permanently-open sprinkler heads that are distributed over the entire zone that is to be protected. The sprinkler network is thus at atmospheric pressure and does not contain any extinguishing agent. It is also said to be “dry”.

The detection network operates conventionally in the same manner as a sprinkler installation of the kind described above: generally, a pipe network is maintained under pressure and includes a set of sprinkler-type heads, each head being provided with a heat-sensitive shutter. In the event of a fire, the breaking or melting of a shutter causes pressure to drop in the pipe network, which pressure drop itself leads to the deluge network being activated.

This activation causes the entire deluge network to be fed with extinguishing agent, e.g. by opening a “deluge” valve and/or by putting a feed pump into operation. The extinguishing agent can then be dispersed immediately over the entire zone.

A protection system of that type is very bulky and expensive, and it requires regular maintenance, in particular in order to avoid leaks, silting up, or corrosion of the detection network, or to remove obstructions from the deluge network, in particular as a result of certain animals nesting in the open sprinkler heads.

Alternatively, the detection network may comprise a set of electronic sensors. Such sensors are nevertheless expensive to install and to maintain, in particular in zones where the production of any sparks is banned.

An object of the invention is to resolve one or more of the above-mentioned problems, at least in part.

### SUMMARY OF THE INVENTION

The invention provides a sprinkler head, in particular for dispensing an extinguishing agent, the sprinkler head comprising:
a body having a transfer channel passing therethrough; and
an endpiece that in a “closed” position closes the transfer channel and that is suitable for disengaging said transfer channel under the effect of an “opening” force exerted on the endpiece.

The endpiece is thus held in position on the body in the closed position and can be moved relative to the body under the effect of the opening force so as to disengage the transfer channel.

The sprinkler head includes means for holding the endpiece on the body, which means are capable of being deactivated merely by applying the opening force, even in the absence of a fire. The sprinkler head may thus be opened solely by exerting the opening force on the endpiece, thus making it possible to dispense an extinguishing agent in locations where no abnormal increase in temperature has been detected, and to do so merely by applying said opening force.

The opening force is preferably less than 1500 newtons (N), preferably less than 900 N, preferably less than 300 N, preferably less than 150 N, preferably less than 90 N, preferably less than 60 N, preferably less than 30 N, or indeed less than 15 N, or even less than 3 N or 1 N.

Typically, the opening force lies in the range 15 N to 80 N.

The “opening” force may in particular result from a pressure difference between the pressure in the transfer channel, referred to as the “internal” pressure, and ambient pressure. This pressure difference is referred to below as the “opening pressure differential”. The opening pressure differential is preferably less than 50 bar, preferably less than 30 bar, preferably less than 10 bar, preferably less than 5 bar, preferably less than 3 bar, preferably less than 2 bar, preferably less than 1 bar, or indeed less than 0.5 bar, or even less than 0.1 bar.

Typically, the opening pressure differential lies in the range 1 bar to 7 bar, or indeed in the range 1.5 bar to 6 bar.

As explained in greater detail in the description below, the sprinkler head is for inserting in a pipe, the shutter isolating the transfer channel (which is itself in communication with the inside of the pipe) from the outside. In the standby situation, the endpiece thus serves to protect the pipe from the outside and to prevent nesting in the pipe.

The endpiece comprises a base having an outlet channel passing therethrough and a shutter held against the base so as to close said outlet channel. Any conventionally-used holding system may be envisaged, and in particular systems that provide rigid fastening of the shutter to the base, e.g. using clips.

In the event of a fire, it suffices to exert an opening force on the endpiece tending to detach it from the body, and in particular, for example, it suffices to increase the pressure in the pipe in order to open the sprinkler head, e.g. by feeding it with the extinguishing agent under pressure.

Alternatively, a vacuum may be maintained in the pipe. It may then suffice to increase the internal pressure, e.g. up to ambient pressure or above, in order to open the sprinkler head.

In a particular embodiment, opening of the sprinkler head results from putting the internal pressure and ambient pressure into equilibrium, with the opening force being constituted, for example, by the weight of the endpiece.

The means for generating the opening force are not limited, and in particular they may comprise: forces resulting from a pressure differential between the internal pressure and ambient pressure; gravity forces, in particular the weight of the endpiece; forces exerted by resilient means, e.g. a compressed spring; forces exerted by electromagnetic means, or any combinations of such means.

A sprinkler head of the invention must enable the endpiece to be maintained in the “closed” position, in particular in a standby situation, and, as a result of an opening force appearing, it must allow a transition towards an “open” position in which the endpiece disengages the transfer channel, at least in part. The opening force thus corresponds to an action exerted on the endpiece and leading to said endpiece substantially disengaging the transfer channel.

Preferably, the endpiece and the body are shaped so that passing from the closed position to the open position leaves the endpiece substantially undamaged, and in particular the portion of the endpiece that is in contact with the body in the closed position.

Preferably, the generation of an opening force does not require electrical energy, at least not in the proximity of the sprinkler head.

Mechanical opening of the sprinkler head is thus simple, fast, and preferably does not require any electrical energy. It is also very reliable.

An increase in the force exerted on the endpiece beyond the opening force, i.e. beyond the force that is strictly necessary for normally causing the sprinkler head to open, may serve to mitigate any potential unexpected blockage. This increase in the force exerted on the endpiece may result in particular from an increase in the pressure differential beyond the opening pressure differential, i.e. beyond the pressure differential that is strictly necessary for normally leading to the sprinkler head being opened.

Finally, the increase of pressure in the pipe advantageously serves to open simultaneously all of the sprinkler heads that are inserted therein.

The opening force is preferably substantially axial.

In the standby situation, a sprinkler head of the invention also serves, advantageously, to maintain a pressure difference between the inside and the outside of the pipe in which it is inserted, which may be useful in particular for detecting the start of a fire.

In particular, the sprinkler head may comprise:
an outlet channel including an inlet in fluid communication with the transfer channel, and an outlet opening to the outside; and
a heat-sensitive shutter closing said outlet channel.

The term “heat-sensitive” is used to mean that the shutter is suitable for disengaging the outlet channel under the effect of an increase in temperature or when a temperature exceeds a determined threshold. This disengaging of the outlet channel by the shutter is conventionally referred to as “activation”. The activation of a shutter that is in the form of a fuse or a bulb, for example, is constituted by it melting or breaking.

In an embodiment, the endpiece may be disengaged under the effect of said optionally-axial opening force without it being necessary for the shutter to be activated, e.g. for the shutter to break, burst, or melt.

In particular, the shutter may be held on the endpiece, e.g. it may be rigidly fastened to the endpiece, and thus move away with the endpiece when it disengages the transfer channel.

The outlet channel may in particular be formed in the endpiece.

A pressure difference between the inside and the outside of the pipe may thus be maintained in the standby situation as a result of the transfer channel being closed by the endpiece and the outlet channel being closed by the shutter. This pressure difference is modified in the event of a fire, when the shutter disengages from the outlet channel. This pressure variation may advantageously serve as a signal indicating that the start of a fire has been detected.

Advantageously, the sprinkler head may thus perform both a function of sprinkling extinguishing agents and a function of detecting fire.

In particular, the shutter may comprise a bulb that is suitable for breaking under the effect of a temperature rise, or a fuse suitable for melting under the same conditions. The shutters conventionally implemented in sprinkler heads may be used.

In the standby situation, the shutter may close the outlet channel in leaktight manner or it may allow a leakage flow between the shutter and the outlet channel. Advantageously, manufacturing tolerances may be small. Nevertheless, if the sprinkler head needs to act as fire detector means, as explained above, it is appropriate to provide means for maintaining a pressure difference between the inside and the outside of the pipe in the standby situation. The leakage flow should nevertheless be limited. Preferably, the passage between the shutter and its seat via which the leak takes place should be less than 5%, less than 1%, indeed less than 0.5% or less than 0.1% of the section of the outlet channel at the seat of the shutter.

Similarly, the endpiece may close the transfer channel in leaktight manner. Nevertheless, in the closed position, a leakage flow may be admitted between the body and the endpiece. It is considered that the passage between the body and the endpiece should preferably be less than 5%, less than 1%, or even less than 0.5% or less than 0.1% of the section of the transfer channel closed by the endpiece.

In the standby situation, the endpiece must remain in the closed position. For this purpose, it may suffice for a vacuum or an equilibrium pressure to be maintained in the transfer channel. Alternatively, or in addition, the sprinkler head may include retaining means for retaining the endpiece in a position for closing the transfer channel, and in particular:
magnetic means; and/or
clip means; and/or
tie means; and/or
friction means; and/or
elastic means, in particular spring means suitable for pushing the endpiece against the body, or elastic materials, in particular for constituting the portions of the endpiece and/or of the body that penetrate one in the other; and/or
adhesive means.

By way of example, the magnetic means may comprise one or more magnets fastened to or incorporated in the endpiece or the body as suitable for co-operating with a magnetic material of the body or of the endpiece, respectively.

In particular, the friction means may be obtained by complementary shapes between the endpiece and the body. For example, the endpiece may have one or more pegs that are received by force in housings of complementary shape in the body. The friction means may also result from inserting a neck of the endpiece inside the transfer channel of the body.

An adhesive may also be placed between the endpiece and the body.

These retaining means may be combined. They are selected, and when adjustable they are optionally adjusted, as a function of the desired opening force or of the desired opening pressure differential.

Whatever the means for holding the endpiece on the body, these means must be selected or adapted to keep the endpiece in the closed position in the absence of a fire and in the absence of the opening force, and to allow it to be disengaged from the transfer channel under the effect of no more than the opening force.

There is no particular difficulty in adapting the above-described means.

The endpiece may be fastened to the body via a hinge, preferably located in such a manner that, on opening, the endpiece can pivot into the “open” position and can preferably be maintained in said position, in particular by gravity.

The sprinkler head may also be provided with resilient return means tending to return the endpiece towards the closed position. The operations for putting the system into the standby situation are thereby simplified.

The body preferably includes fastener means of the type conventionally used for fastening a sprinkler head to a pipe of a fire protection system. The body thus preferably includes a bracket or a thread. The thread preferably corresponds to the thread conventionally used for fastening sprinkler heads. In particular, the thread may comply with the American National Pipe Thread (NPT) standard, e.g. lying in the range NPT ½ inch (in) to NPT 1 in.

In a preferred embodiment, the invention provides a sprinkler head conventionally comprising:
a body having a transfer channel passing therethrough; and
an endpiece closing said transfer channel and having an outlet channel passing therethrough that is in fluid communication with the transfer channel and that is closed by a heat-sensitive shutter, the endpiece being capable of being disengaged from the transfer channel, in particular by exerting a substantially axial opening force.

Unlike prior art sprinkler heads, the endpiece and the body thus do not form a single part, but comprise two parts that can be moved apart, or indeed separated from each other, in particular by an increase of pressure in the transfer channel. Preferably, the endpiece may be capable of disengaging the transfer channel without being damaged and without using a special tool.

The invention also provides a fire protection system that comprises:
a pipe; and
at least one sprinkler head of the invention inserted in said pipe in such a manner that the transfer channel of the sprinkler head is in fluid communication with the inside of said pipe.

In an embodiment, the pipe includes at least one pipe shutter optionally secured to said sprinkler head and isolating the inside volume of the pipe from the outside.

Preferably, the pipe forms part of a pipe network having a plurality of pipe shutters that are preferably identical and that are more preferably regularly distributed over the entire area covered by said pipe network.

The pipe shutter is preferably shaped in such a manner as to put the inside and the outside of the pipe into fluid communication when the temperature surrounding the shutter exceeds a threshold temperature.

The pipe shutter may in particular be a shutter of a sprinkler head that is placed in such a manner as to close an outlet channel of the sprinkler head while in the standby situation, as described above.

The internal pressure inside the pipe is preferably different from ambient pressure, generally atmospheric pressure. Putting the inside of the pipe into communication with the outside thus leads to a change of the internal pressure. This internal pressure variation may be detected and associated with the presence of a fire. That is why a fire protection system of the invention preferably includes means for detecting variation of the internal pressure that exists inside the pipe.

The fire protection system of the invention more preferably includes means for raising the pressure upstream from the endpiece of the sprinkler head so as to give rise to an opening pressure differential and cause the endpiece to disengage the transfer channel.

In an advantageous embodiment in which the internal pressure is lower than ambient pressure and is used on its own for maintaining the endpiece in the closed position, with the disengagement or “opening” of any shutter, e.g. by breaking a bulb forming the shutter, sufficing to give rise to an opening pressure differential.

In an embodiment, the internal pressure is maintained above ambient pressure in the standby situation. The difference between the pressure inside the pipe and ambient pressure must then be less than the opening pressure differential.

In the event of an abnormal situation being detected, in particular in the event of detecting that a shutter has broken, the internal pressure is increased beyond the initial pressure in the standby situation to a value that allows the endpiece to disengage, and more generally allows all of the endpieces of the sprinkler heads of the pipe that to disengage, in particular including the endpieces that are still provided with their shutters.

The protection system of the invention may thus advantageously be used for renovating existing installations in which, in the standby situation, the pipe needs to be maintained at a higher pressure. It suffices merely to replace the sprinkler heads with sprinkler heads of the invention and to adapt the control members in order to be able to eliminate the existing detector means (pipe network or electronic means).

In an embodiment, the fire protection system of the invention includes detector means suitable for detecting a change of the internal pressure inside the pipe, and control means suitable for causing an extinguishing agent to be injected into the pipe in the event of said internal pressure varying, and in particular in the event of said internal pressure increasing.

In the standby situation, the internal pressure is preferably maintained above, or preferably below, ambient pressure, and the detector means are suitable for detecting the opening of a shutter.

In an embodiment, the sprinkler head includes means for acting in the standby situation to compensate leaks that tend to modify the pressure difference between the internal pressure inside the pipe and ambient pressure.

In an embodiment, and in the event of detecting a variation of internal pressure that could correspond to the presence of a fire, the control means open a deluge valve that in the standby situation isolates the pipe from a source of extinguishing agent, and/or they start a feed pump for injecting said extinguishing agent into the pipe.

In an embodiment, after said deluge valve has opened, the source of extinguishing agent is at a pressure that is high enough to cause extinguishing agent to be injected into the pipe without having recourse to a feed pump.

The pressure of the injected extinguishing agent is preferably sufficient to generate an opening pressure differential at the sprinkler head(s) inserted in the pipe. Advantageously, the pressure of the extinguishing agent leads to all of the sprinkler heads opening substantially simultaneously, and thus to the extinguishing agent being dispersed over the entire zone covered by the sprinkler head.

In an embodiment, the fire protection system of the invention includes a source of extinguishing agent, preferably at a pressure that is great enough to create an opening pressure differential at the sprinkler head. The fire protection system may also include means for injecting the extinguishing agent into the pipe at a pressure that is sufficient to create an opening pressure differential at the sprinkler head, and in particular the system may include a deluge valve and/or a feed pump.

The invention also provides an installation, and in particular premises, a warehouse, or a storage tank, including a protection system of the invention. The installation may in particular be a refinery or premises for storing hydrocarbons.

The invention also provides a method of controlling the feeding of extinguishing agent to a pipe having at least one sprinkler head of the invention inserted therein, in which method said feed is initiated in the event of an abnormal variation of the internal pressure in the pipe being detected, in particular in the event of an abnormal increase of the internal pressure, and specifically in the event of an increase of the internal pressure up to ambient pressure. The control method may in particular be applied to opening a deluge valve that isolates the pipe from a source of extinguishing agent or to setting into operation a pump for feeding the pipe with the extinguishing agent.

Finally, the invention provides a method of opening a set of sprinkler heads of a fire protection system of the invention, in which method an opening pressure differential is generated in said pipe in the event of a fire being detected, and preferably the pressure differential is generated with the extinguishing agent.

### DEFINITIONS

The term “opening force” is used to mean a force exerted on the endpiece so as to cause it to disengage, at least in part and preferably completely, the transfer channel by moving the endpiece.

The term “opening pressure differential” is used to mean a pressure difference between the pressure upstream from the endpiece, i.e. inside the transfer channel, and ambient pressure, i.e. on the side of the endpiece that is opposite from the transfer channel, and that is suitable for delivering an opening force. This pressure difference may be positive, or zero, e.g. if the weight of the endpiece suffices to open the sprinkler head, or indeed it may be negative, providing that establishing the opening pressure differential leads to an opening force that is sufficient to open the sprinkler head.

The term “comprising a” should be understood in the description and in the claims as meaning “comprising at least one”, unless specified to the contrary.

### BRIEF DESCRIPTION OF THE FIGURES

Other characteristics and advantages of the invention appear further on reading the following detailed description and on examining the accompanying drawings, in which:

FIGS. 1a, 1b, and 1c are mid-plane longitudinal section views showing sprinkler heads of the invention in a closed position, in a standby situation;

FIGS. 2 and 3 are diagrammatic mid-plane longitudinal section views respectively showing a body and an endpiece of a sprinkler head of the invention;

FIGS. 4 and 5 show the sprinkler head of FIG. 1c respectively at the moment when the shutter breaks and at the moment when the endpiece becomes detached; and

FIG. 6 is a diagram showing a fire protection system of the invention.

In the various figures, identical references are used for designating members that are identical or analogous.

### DETAILED DESCRIPTION OF A PREFERRED EMBODIMENT

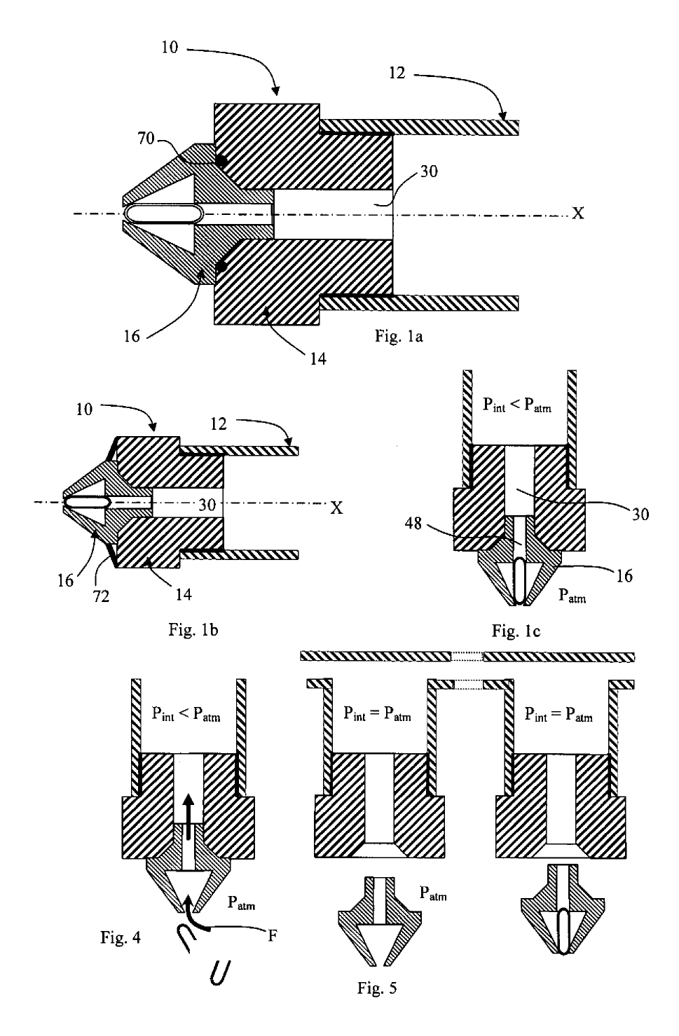

FIG. 1 shows a sprinkler head 10 assembled to a pipe 12 in a fire protection system. The sprinkler head 10, of axis X, comprises a body 14 and an endpiece 16.

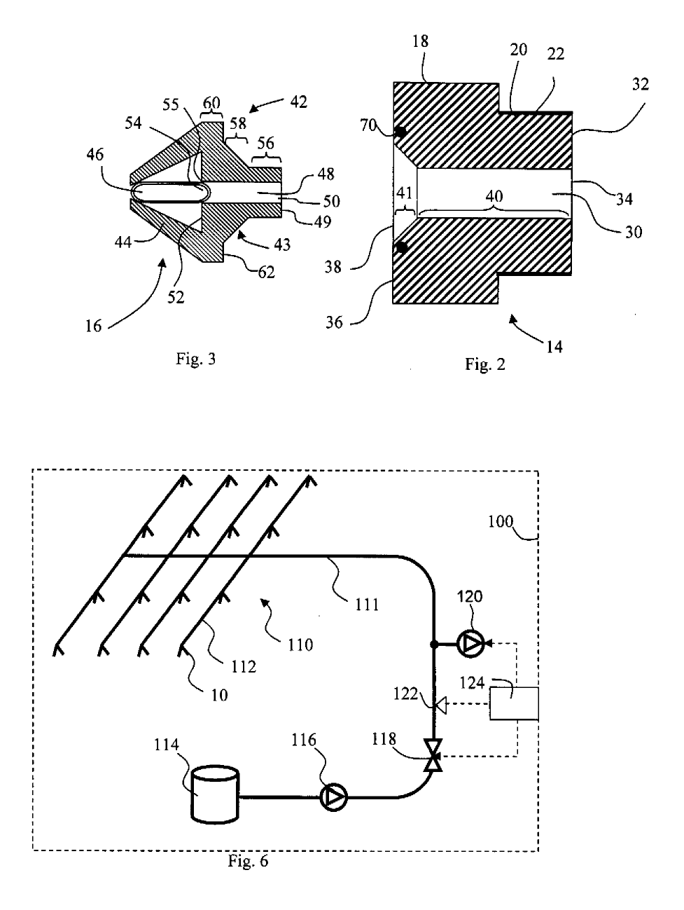

As shown in FIG. 2, the body 14 comprises an outside portion 18 that is substantially cylindrical about the axis X, and that is extended by a neck 20 that is likewise cylindrical about the axis X and that presents a smaller diameter than the outer portion 18. The neck 20 has an outside thread 22 enabling it to be fastened in a complementary thread of the pipe 12.

The body 14 has a substantially rectilinear transfer channel 30 passing therethrough along the axis X and opening out into the upstream face 32 of the body 14 via an inlet opening 34, and into the downstream face 36 via an outlet opening 38. The transfer channel 30 has a cylindrical portion 40 extending from the inlet opening 34, and extended by a frustoconical portion 41 extending to the outlet opening 38.

As shown in FIG. 3, the endpiece 16 comprises a nozzle 42 constituted by a base 43 extended by clips 44, and a shutter 46.

The base 43 has an outlet channel 48 passing therethrough, which channel is closed by the shutter 46 when in the closed position as shown in FIG. 1. The clips 44 hold the shutter 46 in this position.

The outlet channel 48 extends substantially rectilinearly along the axis X and opens out into the upstream face 49 of the base 43 via an inlet 50, and into the downstream face 52 of the base 43 via an outlet 54.

The shutter 46 bears, preferably in substantially leaktight manner, against the edge 55 of the outlet 54, the edge 55 thus acting as a seat for the shutter 46. As explained above, under certain conditions it is possible for there to be a leakage flow between the edge 55 and the shutter 46.

Going from upstream to downstream, the base 43 comprises along the same axis: a first cylindrical base portion 56; a frustoconical base portion 58; and a second cylindrical base portion 60. The first cylindrical base portion 56 and the frustoconical base portion 58 are of shapes complementary to the cylindrical portion 40 and to the frustoconical portion 41 of the transfer channel 30, such that in the closed position as shown in FIG. 1 the first cylindrical base portion 56 and the frustoconical base portion 58 can be inserted in the transfer channel 30 so as to bear over substantially their entire surface areas respectively against the cylindrical portion 40 and the frustoconical portion 41 of the transfer channel 30.

An annular surface 62 that extends substantially radially provides the transition between the frustoconical base portion 58 and the second cylindrical base portion 60 of the endpiece 16.

The endpiece 16 is shown in FIG. 1 in a closed position in which it closes the transfer channel 30. The annular surface 62 is then in contact with the downstream face 36 of the body 14, itself extending substantially radially. Preferably, the contact between the downstream face 36 of the body 14 and the annular surface 62 and/or between the frustoconical portion 41 of the body 14 and the frustoconical base portion 58 of the endpiece 16 and/or between the cylindrical portion 40 of the body 14 and the first cylindrical base portion 56 of the endpiece 16 is contact that is leaktight, i.e. contact that in the closed position does not allow fluid, and in particular gas, to pass between the outside and the transfer channel 30. As explained above, a leakage flow may nevertheless be authorized under certain conditions.

The shutter 46 is in the form of a substantially cylindrical bulb about the axis X and is suitable for breaking on being raised to a temperature higher than a determined threshold temperature, e.g. a temperature greater than or equal to 50° C., and less than 345° C., or indeed less than 80° C.

In the standby situation (FIG. 1), the shutter is held by the clips 44 in a position in which it closes the outlet channel 48.

The clips 44, which may be three to ten in number, for example, leave passages between one another that allow an extinguishing agent leaving the outlet channel 48 via the outlet 54 to pass between them.

In the closed position shown in FIG. 1, the endpiece 16 may be held in position on the body 14 by friction, e.g. because force is required to insert the first cylindrical base portion 56 of the endpiece 16 into the cylindrical portion 40 of the body 14. By way of example, it may equally well be held in position by means of magnets 70 incorporated in the body 14 and co-operating with a mass, e.g. a ferrous mass, of the base 43 of the endpiece 16.

As shown in FIG. 1b, the endpiece 16 could equally well be held by ties 72 suitable for breaking under the effect of an opening force, e.g. resulting from an opening pressure differential.

As shown in FIG. 1c, the endpiece 16 may also be held in position as a result of an internal pressure Pᵢₙₜ inside the transfer channel 30 that is less than the external pressure Pₐₜₘ.

Preferably, this pressure difference on its own suffices to keep the sprinkler head closed.

Also preferably, the sprinkler head is mounted face down so that the weight of the base suffices to make it drop out in the event of the internal pressure being equal to ambient pressure.

As shown in FIG. 6, the sprinkler head 10 may be used in the context of a fire protection system 100. The system 100 shown in FIG. 6 comprises a network 110 of pipes, e.g. fastened to the ceiling of a building that is to be protected. The pipe network 110 comprises a main pipe 111 having secondary pipes 112 branching therefrom and provided with sprinkler heads 10 as described above. The shape of the pipe network 110 and the arrangement of the sprinkler heads 10 are determined in such a manner that the sprinkler heads 10 are distributed substantially uniformly over the entire area that is to be protected. The upstream end of the main pipe 111 is connected to a source of an extinguishing agent, e.g. a tank 114, via a feed pump 116 and/or a deluge valve 118.

The extinguishing agent may be a liquid, a powder, a foam, or a gas, for example.

When the pressure of the extinguishing agent in the tank 114 is sufficient to create an opening pressure differential across the sprinkler heads 10, the pump 116 is not essential for opening the sprinkler heads 10, it being sufficient to open the deluge valve 118 for this purpose. When the extinction pressure in the tank 114 is not sufficient for opening the sprinkler heads 10, the feed pump 116 is essential in order to increase the pressure of the extinguishing agent at the sprinkler heads and create an opening pressure differential.

A vacuum pump 120 may be provided in order to establish and maintain a vacuum inside the pipe network 110 in the standby situation. A sensor 122 is also provided so as to detect any potential changes of pressure in the pipe network 110.

A control unit 124 may also be provided in order to control the vacuum pump 120 whenever the sensor 122 detects a progressive decrease in the pressure inside the pipe network 110, this decrease in pressure corresponding to a leak, in particular at the interface between the endpiece 16 and the body 14 or where the shutter 46 bears against the edge 55 of the outlet channel 48.

When the sensor 122 informs the control unit 124 of a sudden decrease in pressure inside the pipe network 110, the control unit 124 may cause the deluge valve 118 to open and may start the pump 116.

The operation of the protection system shown in FIG. 6 is as follows.

In the standby state, the pipe network 110 is kept dry, at a pressure that is lower than the surrounding pressure by means of the vacuum pump 120. The control unit 124 controls the vacuum pump as a function of information received from the sensor 122 in order to maintain the vacuum in the pipe network 110 at a determined value, in particular in order to take account of leaks via the sprinkler heads, e.g. between the endpiece and the body of a sprinkler head, or between the shutter and its seat, or upstream leaks, e.g. via the deluge valve 118.

This regulation of the vacuum in the pipe network 110 is advantageously capable of accommodating leakage flows, thus limiting the constraints that need to be imposed on the various components of the protection system.

This vacuum in the pipe network also serves to press the endpiece 16 against the body 14 of a sprinkler head, as shown in FIG. 1c. The inclusion of additional retaining means, e.g. magnets, clips, or ties, is therefore not essential, thus making it easier to fabricate the sprinkler heads, and thus limiting their cost.

Retention of the endpiece 16 in position on the body 14 may also be improved by making use of the force of gravity, e.g. by arranging the endpiece in a position such that its weight contributes to pressing it against the body 14. Nevertheless, for security reasons, it is preferable for the weight of the endpiece to contribute to separating it from the body 14, as shown in FIG. 1c.

For the endpiece 16 and/or the body 14, it is also possible to make use of elastic materials so that when it is in the closed position the body 14 holds the endpiece 16 by elastic pressure that results from these materials being compressed.

When a fire appears in the zone covered by the pipe network 110, the local increase in heat causes the shutter in the sprinkler head located close to the fire to break. When the shutter breaks, that disengages the outlet channel 48 of the endpiece 16 in the sprinkler head (FIG. 4). The shutter 46 must nevertheless be shaped so that the vacuum inside the pipe network 110 in the standby situation does not prevent such disengagement. Thus, the sprinkler head 10 is preferably placed with the endpiece at the bottom, and the shutter preferably presents a weight such that the vacuum inside the pipe network 110 cannot hold the shutter or a fragment of the shutter against the outlet channel without help from the clips 44.

In an embodiment, the shutter 46 is held in position closing the outlet channel 48 solely by the vacuum that exists in the pipe network 110. This embodiment nevertheless leads to difficulties during installation and it is therefore preferable for means such as the clips 44 to be provided so as to hold the shutter 46 in the closed position, even in the absence of any vacuum in the pipe network 110.

After the shutter 46 has broken, the outlet channel 48 of the endpiece 16 is unobstructed, thereby causing air to penetrate quickly (arrow F) into the pipe network 110 and thus causing the pressure Pᵢₙₜ inside the network, to increase up to ambient pressure Pₐₜₘ, as shown in FIG. 5.

In the embodiment where the endpieces are held to the bodies of the sprinkler heads solely by the vacuum inside the pipe network, this mere increase in pressure suffices to separate the endpieces, the increase in the internal pressure in the pipe network no longer sufficing to compensate for the weight of the endpieces. All of the endpieces will therefore drop out (FIG. 5).

The sudden increase of internal pressure will also be detected by the control unit 124, which responds by opening the deluge valve 118 and putting the feed pump 116 into operation. The deluge valve 118 may also be opened mechanically under the effect of the increase in the internal pressure, e.g. by activating a pneumatic or hydraulic pilot. It may also be the result of activating a solenoid valve unit that is controlled as a function of the pressure measured by the sensor 122.

Opening the deluge valve 118 and putting the feed pump 116 into operation serve to cause the extinguishing agent contained in the tank 114 to propagate along the main pipe 111 and then along the secondary pipes 112, with the extinguishing agent then being dispersed into the zone that is to be protected via the transfer channels 30 and the sprinkler heads 10.

Furthermore, if the increase in pressure in the pipe network 110 solely as a result of a shutter breaking does not suffice to cause the endpieces 16 to drop out, e.g. as a result of an unexpected blockage or as a result of endpiece retaining means being used on the body so as to hold the endpiece in position in spite of gravity forces, then injecting the extinguishing agent under pressure, generally at an initial pressure of more than 10 bar, and subsequently under steady conditions of about 3 bar to 4 bar, will suffice for detaching the endpieces that are still held against their respective bodies. The retaining means are preferably configured for this purpose.

As can clearly be seen at this point, a sprinkler head of the invention enables fire protection systems to be fabricated that are particularly reliable and inexpensive to install and to maintain.

In particular, a sprinkler head of the invention is capable not only of contributing to detect a fire, but also of sprinkling even if the sprinkler head has not been subjected to an increase in heat. There is therefore no need, as in the prior art, to duplicate the pipe network or to install a multitude of electronic sensors. In addition, in a standby situation, the pipe network can remain dry, thus avoiding the risks of corrosion, of silting up, and of obstruction.

The sprinkler heads may also operate without any electrical power supply, thus enabling them to be deployed, in particular, in zones of the ATEX (atmosphere explosive) type.

Finally, in a standby situation, the pipe network remains closed, thus avoiding in particular any risk of it becoming obstructed by animals nesting.

Naturally, the invention is not limited to the embodiments described and shown, that are given, as illustrative and non-limiting examples. In particular, the protection system may operate with positive pressure, the pressure drop that results from a shutter breaking then serving as a signal indicating that a fire has been detected.

A protection system of the invention is not necessarily configured to respond only in the event of a fire. In particular, it may be configured to respond wherever an abnormal increase in temperature is detected, even in the absence of flames. The system thus contributes to preventing fire, and thus to “protecting” against fire.

The sprinkler head may be a head that is designed for sprinkling drops of water or streams of water. The sprinkler head may also be capable of spraying a mist of water. In particular, present “micro-sprinklers” may be adapted to constitute sprinkler heads of the invention.

1. A sprinkler head for mounting on a pipe of a fire protection system, in particular for dispensing an extinguishing agent, the head comprising:
a body having a transfer channel passing therethrough; and
an endpiece comprising a base having an outlet channel passing therethrough, and a shutter closing said outlet channel, the endpiece in a “closed” position closing the transfer channel and being suitable for disengaging said transfer channel under the effect of an opening force of less than 1500 N.

2. A sprinkler head according to claim 1, said endpiece being suitable for disengaging said transfer channel under the effect of a pressure difference between the pressure (Pᵢₙₜ) inside the transfer channel and ambient pressure (Pₐₜₘ) of less than 50 bar.

3. A sprinkler head according to claim 1, comprising:
an outlet channel including an inlet in fluid communication with the transfer channel and outlet opening to the outside; and
a shutter that is sensitive to heat and that closes said outlet channel.

4. A sprinkler head according to claim 3, said outlet channel being provided in said endpiece.

5. A sprinkler head according to claim 4, allowing a leakage flow between the body and the endpiece and/or, where appropriate, between the shutter and the outlet channel.

6. A sprinkler head according to claim 1, including retaining means for retaining the endpiece in said closed position.

7. A sprinkler head according to claim 6, wherein the retaining means are selected from the group constituted by: magnetic means; clip means; ties; friction means; elastic means; adhesive means; and combinations of these various means.

8. A sprinkler head according to claim 1, wherein the body includes a thread of NPT type.

9. A sprinkler head according to claim 1, wherein the opening force is less than 500 newtons per square centimeter (N/cm²) of transfer channel section closed by said endpiece.

10. A sprinkler head according to claim 9, wherein the opening force is less than 10 N/cm² of transfer channel section closed by said endpiece.

11. A fire protection system comprising:
a pipe;
at least one sprinkler head according to claim 1 inserted in said pipe in such a manner that the transfer channel of the sprinkler head is in fluid communication with the inside of said pipe; and
the internal pressure (Pᵢₙₜ) in said pipe being not equal to ambient pressure (Pₐₜₘ).

12. A system according to claim 11, including:
detector means suitable for detecting a change in the internal pressure (Pᵢₙₜ) inside said pipe; and
control means suitable for causing an extinguishing agent to be injected into said pipe in the event of said internal pressure (Pᵢₙₜ) varying, the pressure of the extinguishing agent sufficing to disengage the endpiece from the transfer channel.

13. A system according to claim 11, the system including means suitable, in a standby situation, for compensating leaks that tend to modify the pressure difference between the internal pressure (Pᵢₙₜ) inside the pipe and ambient pressure (Pₐₜₘ).

14. A system according to claim 11, wherein, in the standby situation, said pipe is kept dry.

15. A system according to claim 11, including a set of sprinkler heads that are regularly spaced apart from one another, wherein each sprinkler head comprises:
a body having a transfer channel passing therethrough; and
an endpiece comprising a base having an outlet channel passing therethrough, and a shutter closing said outlet channel, the endpiece in a “closed” position closing the transfer channel and being suitable for disengaging said transfer channel under the effect of an opening force of less than 1500 N.
